(19) United States
(12) Patent Application Publication
(10) Pub. No.: US 2013/0166558 A1
(43) Pub. Date: Jun. 27, 2013

(54) METHOD AND SYSTEM FOR CLASSIFYING ARTICLE

(71) Applicants: Hahn-Ming Lee, Taipei City (TW); Shou-Wei Ho, Taipei City (TW); Chung-Hung Lin, Taipei City (TW); Ya-Huei Lin, Taipei City (TW); Kuo-Ping Wu, Taipei City (TW); Jerome Yeh, Taipei City (TW)

(72) Inventors: Hahn-Ming Lee, Taipei City (TW); Shou-Wei Ho, Taipei City (TW); Chung-Hung Lin, Taipei City (TW); Ya-Huei Lin, Taipei City (TW); Kuo-Ping Wu, Taipei City (TW); Jerome Yeh, Taipei City (TW)

(73) Assignee: National Taiwan University of Science and Technology, Taipei City (TW)

(21) Appl. No.: 13/549,759

(22) Filed: Jul. 16, 2012

(30) Foreign Application Priority Data
Dec. 27, 2011 (TW) 100148780

(51) Int. Cl. G06F 17/30

(52) U.S. Cl. 707/737; 707/E17.089

(57) ABSTRACT

The present invention discloses a method and system for classifying articles. The present invention can be not only capable of distinguishing the type of the article but also novelty to generate an overview article automatically in accordance with the initial prepared keyword combination or articles. Furthermore, the overview article described above comprises a representative topic corresponding to the content of the initial prepared articles, wherein the representative topic is also able to identify the field of the articles. Accordingly, by the said overview article, the present invention is capable of decreasing the time required to understand the spirit and the technical aspect of the articles so as to solve the long lasted problem of the prior art.

### BACKGROUND OF THE INVENTION

1. Field of the Invention

The present invention relates to a method and system for classifying article, and more particularly to a method and system which can be capable of distinguishing the type of the article and novelty to establish an overview article automatically.

2. Description of the Prior Art

With the rapid expansion of knowledge and technology, how to find the relevant articles or documents has become a demanding task for everyone. In the conventional methods for classifying articles automatically, the data should be trained and assessed first to establish a corresponding database by data mining technologies, and then the articles can be classified according to the database.

However, the conventional methods mentioned above classifies the article categories based on knowledge base system. That is to say, the same proper nouns can not be distinguished in different fields through the prepared database, therefore causing some articles to be classified into an improper category.

Generally speaking, the article categories can be obtained from the domain labeled article titles. Although the articles with the domain labeled titles, some specific terms may be possible of having different applications, and lead to the difficulty in distinguishing the meaning of the confused term.

Accordingly, how to classify articles with the domain labeled titles efficiently is a challenge need to be overcome.

### SUMMARY OF THE INVENTION

Therefore, in order to improve the problem described previously, an aspect of the invention is to provide a method for classifying article, more specifically, this method comprises several steps: preparing a second database; providing a plurality of articles; extracting a plurality of second keyword combinations from the articles correspondingly; obtaining a plurality of categorized data from the second database according to the second keyword combinations correspondingly; producing an analysis data according to the categorized data; and producing a fuzzy ontological knowledge data according to the second keyword combinations, the categorized data and the analysis data.

In actual application, before the step of extracting a plurality of second keyword combinations, the method of present invention further preprocesses the articles with a predetermined condition. Moreover, the step of providing a plurality of articles further comprises a plurality of substeps: preparing a first database; providing a first keyword combination; and extracting the plurality of articles from the first database according to the first keyword combination.

In addition, after the step of producing an analysis data according to the categorized data, the method further comprises the following step of: clustering a third keyword combination corresponding to the articles according to the fuzzy ontological knowledge data; clustering a representative topic for the third keyword combination according to the fuzzy ontological knowledge data; and establishing an overview article according to the third keyword combination and the representative topic.

To sum up, the present invention disclosures a method and system for classifying article, which can be capable of distinguishing the type of the article and novelty to establish an overview article automatically. To be noticed, the overview article described above comprises a representative topic corresponding to the content of the initial prepared articles, wherein the representative topic is also able to identify the field of the articles. Accordingly, by the said overview article, the present invention is capable of decreasing the time required to understand the spirit and the technical aspect of the articles so as to solve the long lasted problem of the prior art.

Many other advantages and features of the present invention will be further understood by the detailed description and the accompanying sheet of drawings.

### BRIEF DESCRIPTION OF THE APPENDED DRAWINGS

FIG. 1 is a flowchart illustrating a method for classifying article according to the present invention.

FIG. 2 is a functional block diagram illustrating a system for classifying article according to the present invention.

To facilitate understanding, identical reference numerals have been used, where possible to designate identical elements that are common to the figures.

### DETAILED DESCRIPTION OF THE INVENTION

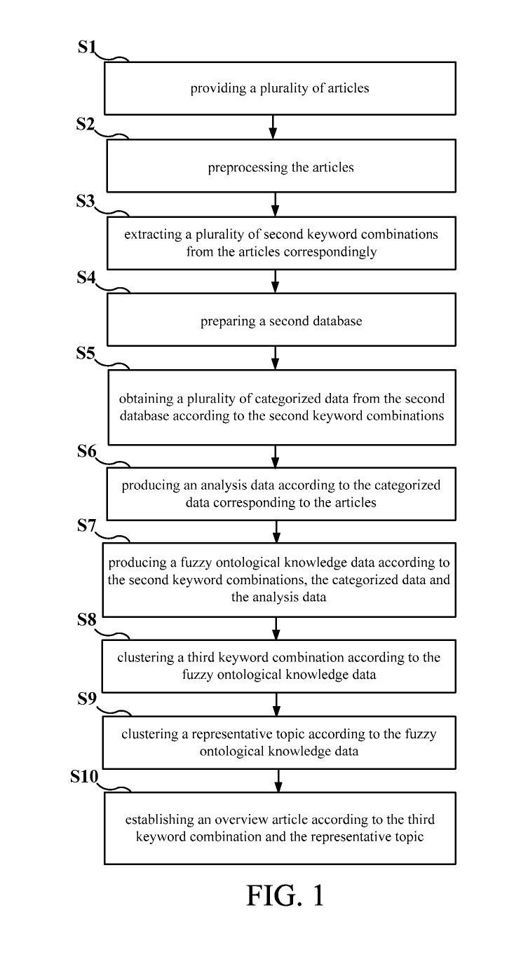

Please refer to FIG. 1. FIG. 1 is a flowchart illustrating a method for classifying article according to the present invention. As shown in FIG. 1, the present invention comprises the steps S1 to S10.

At step S1: providing a plurality of articles first. More precisely, the plurality of articles can be patent specifications, but it is not limited to this. The articles mentioned above may be other documents composed of various numerals, alphabet letters, symbols, and/or word characters. Furthermore, the articles can be obtained from the published patent database of Taiwan Intellectual Property Office (TIPO) according to a first keyword combination, or through a prearranged database and a keyword combination to retrieval the corresponding articles.

Additionally, the step S1 further comprises three substeps S11 to S13. Step S11 is to prepare a first database. In the embodiment, the first database is the published patent database of Taiwan Intellectual Property Office (TIPO), but it is not limited to this embodiment, according to user's demand, the first database may be a digital library of theses and dissertations, Google or other literature archives.

Step S12 is to provide a first keyword combination predetermined by the user. In this embodiment, the first keyword combination can be “portable and projector”; step S13 is to extract the plurality of articles from the first database according to the first keyword combination. In other words, the articles are obtained from the first database with a retrieval condition “portable and projector”. To be noticed, the articles and the first keyword combination need not be limited to the embodiment described above.

After step S1, step 2 is to preprocess the plurality of articles with a predetermined condition, so as to filter and remove the undesirable articles or rank the priority of the articles. In this embodiment, the predetermined condition mentioned above may comprise the lexical frequency, the type or the file size of article. To be noticed, the step S2 may be omitted depending on user's demand.

Step S3 is to extract a plurality of second keyword combinations from the articles correspondingly. More precisely, the contents of the articles are divided into several parts in accordance with the sections thereof first, and then, at least one keyword of a representative article can be extracted to be the second keyword combinations according to an assigned section. In the embodiment, the present invention extracts a second keyword combination through linguistic approach, but it is not limited to be this; step S3 can be performed through other methods, such as: dictionary approach or statistical approach.

Subsequently, step S4 is to prepare a second database. Wherein, the second database is a presorted document library. In this embodiment, the second database is including but not limited to the published patent database of Taiwan Intellectual Property Office (TIPO), Wikipedia, literature archives, or other presorted document libraries.

At step S5, pluralities of corresponding categorized data are obtained from the second database according to the second keyword combinations correspondingly. Take the embodiment as an example, the categorized data corresponding to the second keyword combination is a number of International Patent Classification (IPC), but it is not limited to be this form, the second keyword combination mentioned above can be an institution name of these or dissertation, or the category of Wikipedia. To be noticed, the categorized data of the present invention is composed of at least one of numerals, alphabet letters, symbols, and/or word characters.

Step S6 is to produce an analysis data according to the categorized data. More precisely, step S6 is performed by computing the categorized data of step S5 with a corresponding exterior database, further to capture the features thereof and establish a fuzzy relation model between each data. In actual application, the exterior database mentioned above is a text database which uses the categorized data as an index, including but not limited to the first or second database. Furthermore, the fuzzy relation model is constructed by an algorithm based on Fuzzy set theory (FST). In the present invention, the algorithm based on Fuzzy set theory need not be limited to the description above.

After establishing the fuzzy relation model, step S7 is performed to produce a fuzzy ontological knowledge data according to the second keyword combinations, the categorized data and the analysis data. Since the algorithm of the fuzzy ontological knowledge data and the fuzzy relation model are relative with each other, the computational method thereof needs not to be elaborated further.

Therefore, the fuzzy ontological knowledge data mentioned above can recognize the categories of each article automatically, so as to classify articles. To be noticed, the method of present invention can further generate an overview article automatically in accordance with the initial prepared keyword combination or articles, thus the time required to understand the spirit and the technical aspect of the articles can be reduced.

In order to generate the overview article mentioned above, the present invention further comprises steps S8 to S10. Step 8 is to cluster a third keyword combination corresponding to the articles according to the fuzzy ontological knowledge data; step S9 is to cluster a representative topic for the third keyword combination according to the fuzzy ontological knowledge data; and step S10 is to establish an overview article according to the third keyword combination and the representative topic.

More precisely, steps S8 and S10 is performed with the algorithm based on Latent Dirichlet Allocation. Wherein, the third keyword combination represents the keyword set of each article; and, the representative topic is used for representing a topic sentence of the third keyword combination. Furthermore, the third keyword combination and the topic sentence described above are composed of at least one of numerals, alphabet letters, symbols, and/or word characters. To be noticed, the word (number of letters) of the representative topic is less than the third keyword combination.

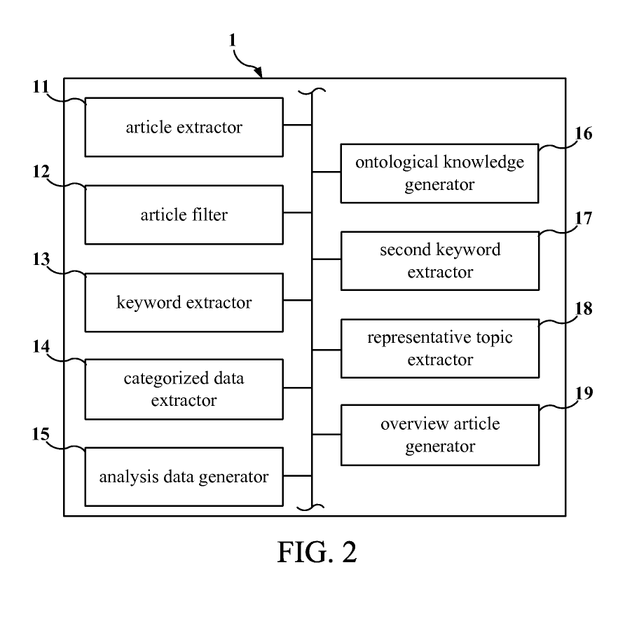

In addition, another aspect of the invention is to provide a system for classifying article. Please refer to FIG. 2. FIG. 2 is a functional block diagram illustrating a system for classifying article according to the present invention. As shown in FIG. 2, the system for classifying article 1 comprises an article extractor 11, an article filter 12, a keyword extractor 13, a categorized data extractor 14, an analysis data generator 15, an ontological knowledge generator 16, a second keyword extractor 17, a representative topic extractor 18, and an overview article generator 19.

Wherein, the keyword extractor 13 is coupled to the article extractor 11, and used for extracting a plurality of second keyword combinations from the articles correspondingly. The categorized data extractor 14 is coupled to the keyword extractor 13, and used for obtaining a plurality of categorized data from the second database according to the second keyword combinations correspondingly. The analysis data generator 15 is coupled to the categorized data extractor 14, and used for producing an analysis data according to the categorized data. Moreover, the ontological knowledge generator 16 is coupled to the analysis data generator 15, and used for producing a fuzzy ontological knowledge data according to the second keyword combinations, the categorized data and the analysis data.

The article filter 12 mentioned previously is coupled to the article extractor 11, and used for preprocessing the articles with a predetermined condition. Therefore, the plurality of articles can be filtered or ranked by the article filter 12. Additionally, the second keyword extractor 17 is coupled to the ontological knowledge generator 16, for clustering a third keyword combination corresponding to the articles according to the fuzzy ontological knowledge data. And, the representative topic extractor 18 is coupled to the second keyword extractor 17, for clustering a representative topic for the third keyword combination according to the fuzzy ontological knowledge data. The overview article generator 19 is coupled to the representative topic extractor 18, for establishing an overview article according to the third keyword combination and the representative topic.

To be noticed, the components described above are the physical devices with corresponding functions, but it is not limited to the embodiments mentioned previously. Hence, the components of present invention can be the virtual application programs with corresponding functions or other devices being capable of executing the application programs.

Accordingly, the present invention disclosures a method and system for classifying article, which can be capable of distinguishing the type of the article and novelty to establish an overview article automatically. To be noticed, the overview article described above comprises a representative topic corresponding to the content of the initial prepared articles, wherein the representative topic is also able to identify the field of the articles. Accordingly, by the said overview article, the present invention is capable of decreasing the time required to understand the spirit and the technical aspect of the articles so as to solve the long lasted problem of the prior art.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for classifying article, comprising the following steps of:
preparing a second database;
providing a plurality of articles;
extracting a plurality of second keyword combinations from the articles correspondingly;
obtaining a plurality of categorized data from the second database according to the second keyword combinations correspondingly;
producing an analysis data according to the categorized data; and
producing a fuzzy ontological knowledge data according to the second keyword combinations, the categorized data and the analysis data.

2. The method for classifying article of claim 1, wherein before the step of extracting a plurality of second keyword combinations from the articles correspondingly, the method further comprises the following step of:
preprocessing the articles with a predetermined condition.

3. The method for classifying article of claim 1, wherein the step of providing a plurality of articles further comprises a plurality of substeps:
preparing a first database;
providing a first keyword combination; and
extracting the plurality of articles from the first database according to the first keyword combination.

4. The method for classifying article of claim 1, wherein after the step of producing an analysis data according to the categorized data, the method further comprises the following step of:
clustering a third keyword combination corresponding to the articles according to the fuzzy ontological knowledge data;
clustering a representative topic for the third keyword combination according to the fuzzy ontological knowledge data; and
establishing an overview article according to the third keyword combination and the representative topic.

5. A system for classifying article, comprising:
an article extractor, used for extracting a plurality of articles from a first database according to a first keyword combination set by a user;
a keyword extractor, coupled to the article extractor, for extracting a plurality of second keyword combinations from the articles correspondingly;
a categorized data extractor, coupled to the keyword extractor, for obtaining a plurality of categorized data from the second database according to the second keyword combinations correspondingly;
an analysis data generator, coupled to the categorized data extractor, for producing an analysis data according to the categorized data; and
an ontological knowledge generator, coupled to the analysis data generator, for producing a fuzzy ontological knowledge data according to the second keyword combinations, the categorized data and the analysis data.

6. The system for classifying article of claim 5, further comprising an article filter, coupled to the article extractor, for preprocessing the articles with a predetermined condition.

7. The system for classifying article of claim 5, further comprising a second keyword extractor, coupled to the ontological knowledge generator, for clustering a third keyword combination corresponding to the articles according to the fuzzy ontological knowledge data.

8. The system for classifying article of claim 7, further comprising a representative topic extractor, coupled to the second keyword extractor, for clustering a representative topic for the third keyword combination according to the fuzzy ontological knowledge data.

9. The system for classifying article of claim 8, further comprising an overview article generator, coupled to the representative topic extractor, for establishing an overview article according to the third keyword combination and the representative topic.
